(19) United States
(12) Patent Application Publication
(10) Pub. No.: US 2009/0102897 A1
(43) Pub. Date: Apr. 23, 2009

(54) Liquid Contanier

(75) Inventors: Tadahiro MIZUTANI, Shiojiri-shi (JP); Hiroshi NOSE, Shiojiri-shi (JP); Akihisa WANIBE, Matsumoto-shi (JP); Taku ISHIZAWA, Matsumoto-shi (JP); Takayoshi KATSUMURA, Matsumoto-shi (JP); Yuichi NISHIHARA, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/255,565

(22) Filed: Oct. 21, 2008

(30) Foreign Application Priority Data
Oct. 23, 2007 (JP) 2007-275491

(51) Int. Cl. B41J 2/175

(52) U.S. Cl. 347/85

(57) ABSTRACT

A liquid container for supplying a liquid to a liquid jetting apparatus includes a liquid reservoir section and a sensor. The liquid reservoir section stores electrically conductive liquid. The sensor is disposed at a location in the liquid reservoir section, for electrically detecting a condition of the conductive liquid at the location. A fixed potential is applied to the conductive liquid.

### CROSS REFERENCE TO RELATED APPLICATIONS

This application relates to and claims priority from Japanese Patent Application No.2007-275491, filed on Oct. 23, 2007, the entire disclosure of which is incorporated by reference.

### BACKGROUND

1. Technical Field

The present invention relates to a liquid container for supplying liquid to the liquid jetting apparatus.

2. Description of the Related Art

Ink-jet printers adapted for installation of one or more ink cartridges containing ink and to carry out printing onto a printing medium by consuming the ink supplied from the ink cartridges are known in the art. Ink cartridges of this kind equipped with a sensor for electrically sensing the condition of consumption of ink contained therein are also known in the art.

However, if an ink has electrical conductivity, extraneous noise may interfere through the medium of the ink, posing the risk of diminished sensing accuracy of the sensor. This issue is not limited to ink-jet printers, but is a problem common to liquid jetting apparatus, for example, apparatus for jetting a liquid material containing a metal component onto a semiconductor in order to form the electrode layer.

### SUMMARY

It is accordingly one object of the present invention to limit interference, through the medium of the ink, with a sensor that electrically detects the condition of a conductive liquid such as ink.

A first aspect of the invention provides a liquid container for supplying a liquid to a liquid jetting apparatus. The liquid container comprises a liquid reservoir section and a sensor. The liquid reservoir section stores electrically conductive liquid. The sensor is disposed at a location in the liquid reservoir section, for electrically detecting a condition of the conductive liquid at the location. A fixed potential is applied to the conductive liquid.

According to the liquid container of the first aspect, the fixed potential is applied to the conductive liquid, thereby reducing interference of extraneous noise with the sensor through the medium of the conductive liquid. The sensing accuracy of the sensor may be improved as a result, for example.

The liquid container pertaining to the first aspect may comprise a first conducting portion. The conducting portion may form at least part of an inside face of the liquid reservoir section. The inside face contacts the conductive liquid. The conducting portion is electrically connected to a power supply that supplies the fixed potential. In this case, the conductive liquid may be easily connected to the fixed potential.

In the liquid container pertaining to the first aspect, when the liquid container is installed in the liquid Jetting apparatus, the conductive liquid may contact a conducting portion of the liquid jetting apparatus that is electrically connected to the fixed potential. In this case, on the liquid jetting apparatus side, the conductive liquid may be connected to the fixed potential.

In the liquid container pertaining to the first aspect, the conductive liquid may flow through an interior of the liquid reservoir section when being consumed by the liquid jetting apparatus. The conductive liquid may be electrically connected to the fixed potential at an upstream side and a downstream side of the sensor. In this case, the conductive liquid is electrically connected to fixed potential both at the upstream side and the downstream side of the sensor, whereby interference of extraneous noise with the sensor through the medium of the conductive liquid may be reduced more effectively.

In the liquid container pertaining to the first aspect, the liquid reservoir section may include a U-shaped channel. The that U-shaped channel may include a first channel, a second channel at an upstream side of the first channel, and a third channel at an downstream side of the first channel. The sensor may be situated along the first channel. The liquid container may further comprise a first conducting portion and a second conducting portion. The first conducting portion may define at least part of an inside face of the second channel. The inside face of the second channel may contacts the conductive liquid. The first conducting portion may be electrically connected to the fixed potential. The second conducting portion may define at least part of an inside face of the third channel. The inside face of the third channel may contacts the conductive liquid. The second conducting portion may be electrically connected to the fixed potential. In this case, the conductive liquid is connected to the fixed potential both at the upstream side and the downstream side of a U-shaped channel in which the sensor is disposed, whereby interference of extraneous noise with the sensor through the medium of the conductive liquid may be reduced more effectively.

The liquid container pertaining to the first aspect may further comprise a conducting member and a sensor module. The conducting member may include the first conducting portion and the second conducting portion. The sensor module may include the sensor and the first channel. The conducting member may be a seating where the sensor module is situated. In this case, since the seating in which the sensor module is situated is employed as the electrical conductor for connecting the conductive liquid to the fixed potential, the conductive liquid may be connected to the fixed potential through a simple construction.

In the liquid container pertaining the first aspect, the liquid reservoir section may include a differential pressure regulating valve. The differential pressure regulating valve may be inside a channel that supplies the conductive liquid to the liquid jetting apparatus. The differential pressure regulating valve may include a conductive member contacting the conductive liquid. The conductive member may be connected to the fixed potential. In this case, since a member making up the differential pressure regulating valve is employed as the electrical conductor for connecting the conductive liquid to the fixed potential an increase in the number of parts may be avoided.

In the liquid container pertaining the first aspect, the conductive member may be electrically connected to the conductive liquid on an upstream side and the conductive liquid on a downstream side. When the liquid container is installed in the liquid jetting apparatus, the conductive liquid on the downstream side may contact a conducting portion of the liquid jetting apparatus that is electrically connected to the fixed potential. In this case, despite physical separation between the upstream side and the downstream side, the conductive liquid is electrically connected through the electrical conductor. As a result, the conductive liquid on the upstream side may be connected to the fixed potential by the electrical conducting portion on the liquid jetting apparatus side.

In the liquid container pertaining the first aspect, the first conducting portion substantially may cover a projected area of the conductive liquid inside the liquid reservoir section viewed from a prescribed direction. In this case, since, viewed from a prescribed direction, the conductive liquid as a whole is covered by an electrical conductor that is connected to the fixed potential, noise coming from the prescribed direction can be effectively shielded.

In the liquid container pertaining the first aspect, the conducting portion may be a nozzle member of the liquid jetting apparatus that has nozzles for jetting the conductive liquid. In this case, since the nozzle member on the liquid jetting apparatus side is employed as the electrical conductor for connecting the conductive liquid to the fixed potential, the liquid container may have simpler construction.

In the liquid container pertaining the first aspect, when the liquid container is installed in the liquid jetting apparatus, the conductive liquid may be electrically connected to the frame ground of the liquid jetting apparatus having the fixed potential.

The above and other objects, characterizing features, aspects and advantages of the invention will be clear from the description of preferred embodiments presented below along with the attached drawings.

### BRIEF DESCRIPTION OF THE DRAWINGS

FIG. 1 is an illustration depicting a simplified configuration of a printing system in first embodiment;

FIG. 2 is a diagram depicting an ink cartridge attached to a print head unit;

FIG. 3 is a first exterior perspective view of an ink cartridge in first embodiment;

FIG. 4 is a second exterior perspective view of an ink cartridge in the first embodiment;

FIG. 5 is a first exploded perspective view of an ink cartridge in the first embodiment;

FIG. 6 is a second exploded perspective view of an ink cartridge in the first embodiment;

FIG. 7 is a conceptual depiction of the pathway leading from the open air hole to the liquid supply portion;

FIG. 8 is a diagram of the cartridge body viewed from the front;

FIG. 9 is a diagram of the cartridge body viewed from the back;

FIG. 10A is simplified schematic of FIG. 8;

FIG. 10B is simplified schematic of FIG. 9;

FIG. 11 is a diagram illustrating the configuration of the sensor portion in the first embodiment;

FIG. 12 is a diagram of the electrical configuration centered on a piezoelectric device that included in the sensor in the first embodiment;

FIG. 13 is a diagram of an electrical configuration centered on a piezoelectric device that constitutes the sensor in the comparative example;

FIG. 14 is a diagram depicting a simplified cross section of construction in an area from the vicinity of the differential pressure regulating valve to the liquid supply portion 50, shown together with a simplified cross section of the print head;

FIG. 15 is a diagram illustrating the configuration of the sensor portion in second embodiment;

FIG. 16 is a diagram of the electrical configuration centered on a piezoelectric device that constitutes the sensor in the second embodiment;

FIG. 17 is an exploded perspective view of an ink cartridge in a variation of the second embodiment;

FIG. 18 is a diagram of the electrical configuration centered on a piezoelectric device that constitutes the sensor in the variation of the second embodiment;

FIG. 19 depicts a hermetic type ink cartridge in front view and in side view;

FIG. 20 is a first diagram depicting the B-B cross section in FIG. 19; and

FIG. 21 is a second diagram depicting the B-B cross section in FIG. 19.

### DETAILED DESCRIPTION OF THE PREFERRED EMBODIMENTS

Next, the preferred embodiments for carrying out the invention will be described based on the accompanying drawings.

### A. First Embodiment

Printer and Ink Cartridge Configuration:

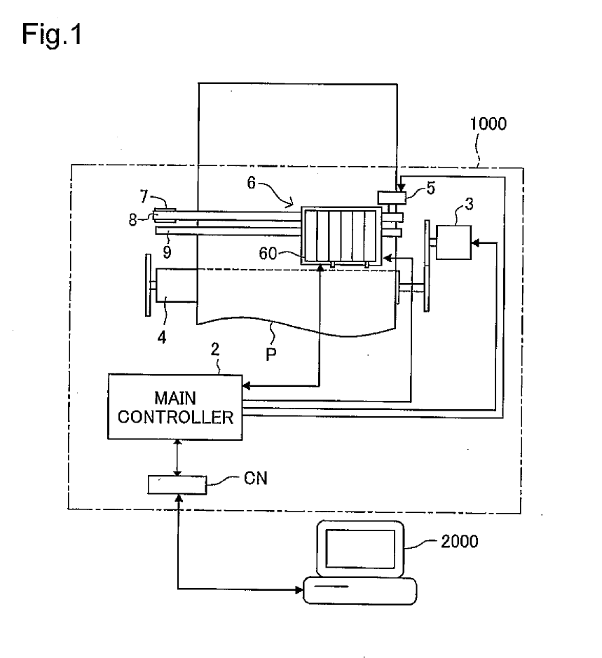

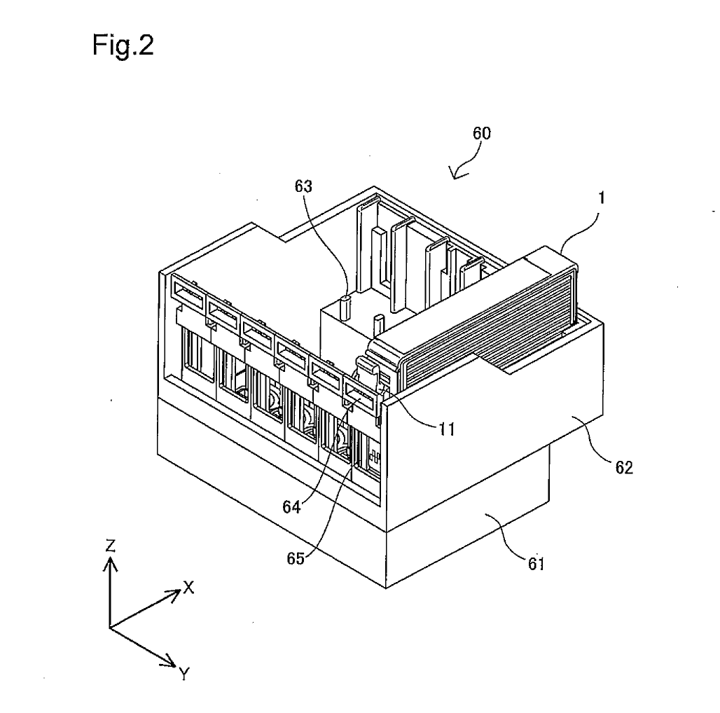

The configuration of a printer according to a first embodiment will be described with reference to FIGS. 1 and 2. FIG. 1 is an illustration depicting a simplified configuration of a printing system in first embodiment. FIG. 2 is a diagram depicting an ink cartridge attached to a print head unit.

The printing system includes a printer 1000 and a computer 2000. The printer 1000 is connected to the computer 2000 through a connector CN.

The printer 1000 is equipped with a sub-scan feed mechanism, a main scan feed mechanism, a head driving mechanism, and a main controller 2 for controlling these mechanisms. The sub-scan feed mechanism includes a paper feed motor 3 and a platen 4, and functions to transport paper P in the sub-scanning direction through transmission of the rotation of the paper feed motor to the platen. The main scan feed mechanism includes a carriage motor 5, a pulley 7, a drive belt 8 stretched between the carriage motor 5 and the pulley 7, and a slide rail 9 disposed parallel to the axis of the platen The slide rail 9 slidably retains a carriage 6 that is affixed to the drive belt 8. Rotation of the carriage motor 5 is transmitted to the carriage 6 via the drive belt 8, whereby the carriage 6 reciprocates in the axial direction of the platen 4 (the main scanning direction)along the slide rail 9. The head driving mechanism includes a print head unit 60 that rests on the carriage 6; the print head is driven in order to eject ink onto the paper P. Above the print head unit 60 is disposed a holder (not shown in FIG. 1), discussed later, adapted for detachable installation of plurality of ink cartridges. The printer 1000 is additionally includes an operation section enabling the user to make various settings or check the printer status; however, these need not be discussed in detail.

As depicted in FIG. 2, the print head unit 60 includes a print head 61, and a holder 62 situated on the upper face of the print head 61. The holder 62 is designed to accommodate installation of several ink cartridges 1. Projections 63 and recessed portions 64 are formed in the holder 62 for the purpose of positioning and fastening the ink cartridges 1. A carriage circuit and a connection mechanism having connecting pins (terminals) (not shown) are disposed at the aperture 65 of the holder 62 towards the negative direction along the X axis. Ink supply needles, discussed later, are disposed on the upper face to the print head 61.

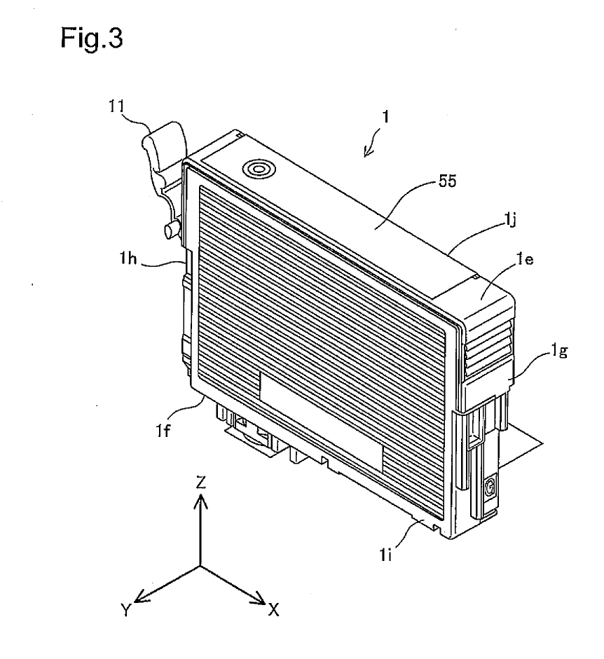

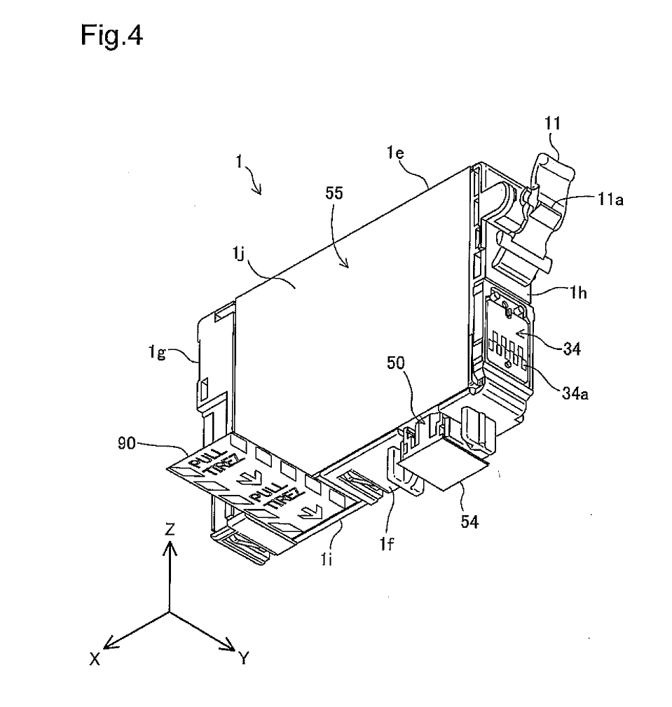

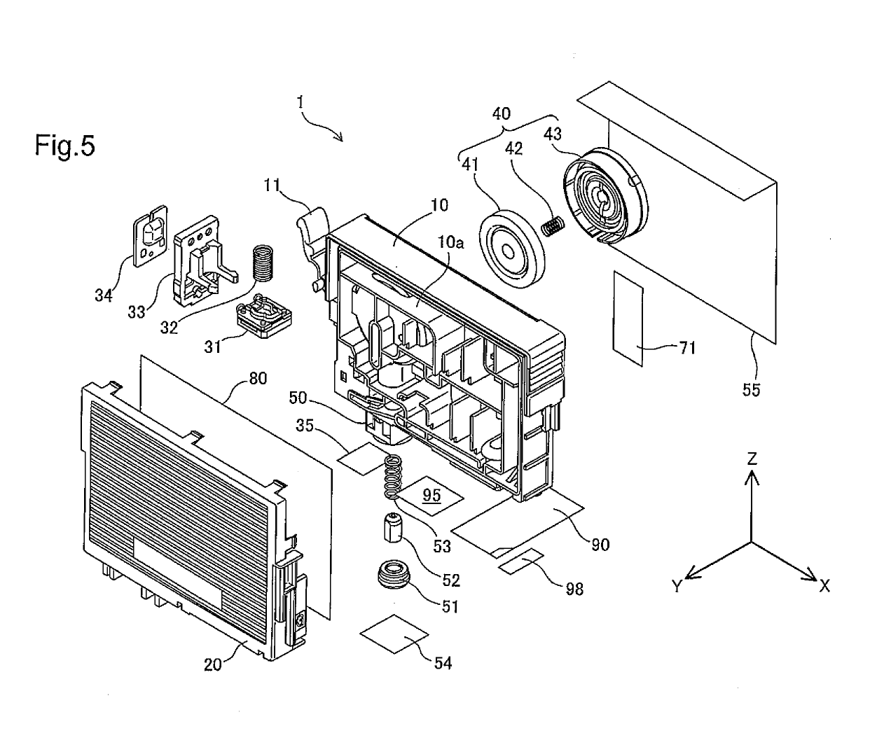

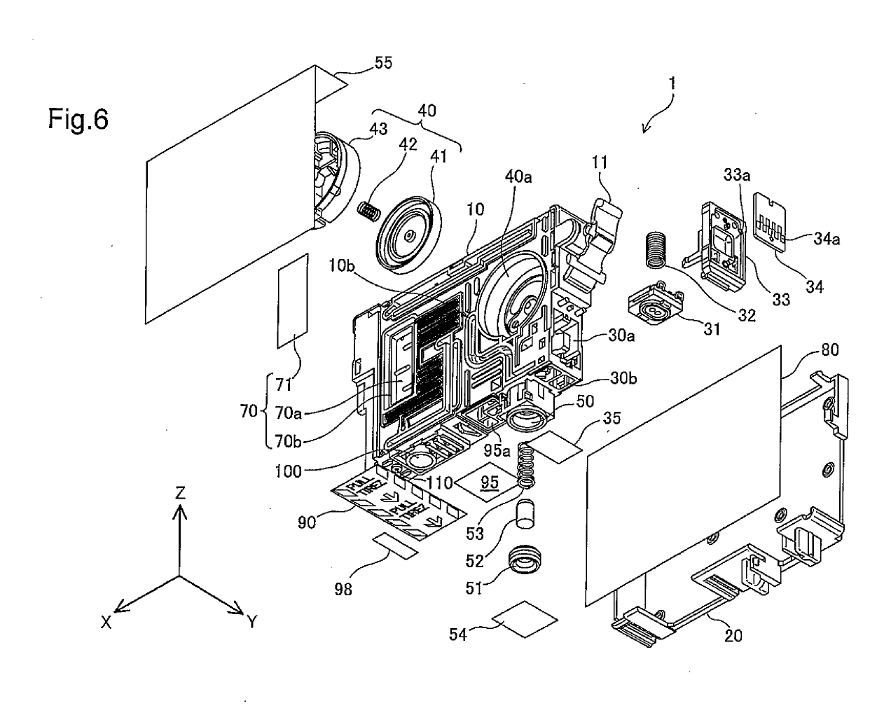

Referring now to FIGS. 3 to 6 in addition to FIG. 2, the ink cartridges 1 will be discussed further. FIG. 3 is a first exterior perspective view of an ink cartridge in first embodiment. FIG. 4 is a second exterior perspective view of an ink cartridge in first embodiment. The drawing in FIG. 4 is viewed from the opposite direction from than in FIG. 3. FIG. 5 is a first exploded perspective view of an ink cartridge in first embodiment. FIG. 6 is a second exploded perspective view of an ink cartridge in first embodiment. The drawing in FIG. 6 is viewed from the opposite direction from than in FIG. 5.

The ink cartridge 1 contains a conductive liquid ink inside. With the ink cartridge 1 installed in the holder 2 as depicted in FIG. 2, the ink will be supplied to the print head 61 through the ink supply needle.

As depicted in FIGS. 3 and 4, the ink cartridge 1 has a generally rectangular parallelepiped shape having a face 1e on the Z axis positive direction side, a face 1f on the Z axis negative direction side, a face 1g on the X axis positive direction side, a face 1h on the X axis negative direction side, a face 1i on the Y axis positive direction side, and a face 1j on the Y axis negative direction side. Hereinbelow, for convenience in discussion, face 1e shall be termed the upper face; face 1f the lower face; face 1g the right face; face 1h the left face; face 1i the front face; and face 1j the back face. The sides at which these faces 1e to 1j are located shall be termed the upper face side, the lower face side, the right face side, the left face side, the front face side, and the back face side, respectively.

On the lower face 1f is provided a liquid supply portion 50 having a supply hole for supplying ink to the ink-jet printer. Additionally, an open air hole 100 allowing air to be introduced into the ink cartridge 1 opens onto the bottom face 1f (FIG. 6).

The open air hole 100 is formed with a depth and diameter such that it will mate, with enough leeway to form a prescribed gap, with one of the projections 63 (FIG. 2) that have been formed on the print head unit 60 of the ink-jet printer. The user will remove a sealing film 90 that air-tightly seals the open air hole 100, then install the ink cartridge 1 in the holder 62. The projection 63 has the function of preventing the user from forgetting to remove the sealing film 90.

A locking lever 11 is provided on the left side face 1h. A projection 11a is formed on the locking lever 11. With the ink cartridge 1 installed in the holder 62, the projection 11a will mate with one of the recessed portions 64 of the holder 62 thereby fastening the ink cartridge 1 to the holder 62 (FIG. 2).

A circuit board 34 is disposed below the locking lever 11 of the left side face 1h (FIG. 4). A number of electrode terminals 34a are formed on the circuit board 34; these electrode terminals 34a provide electrical connection to the carriage circuit via a connecting mechanism (not shown) that has been provided to the carriage 6.

An outside surface film 55 is adhered to the upper face 1e and the back face 1j of the ink cartridge 1.

The internal construction and parts configuration of the ink cartridge 1 will now be described with reference to FIGS. 5 and 6. The ink cartridge 1 has a cartridge body 10 and cover member 20 that covers the front face side of the cartridge body 10.

Ribs 10a of various shapes are formed on the front face side of the cartridge body 10 (FIG. 5). Between the cartridge body 10 and the cover member 20 is disposed a film 80 covering the front face side. The film 80 adheres intimately so as to prevent gaps from forming at the front face-side edges of the ribs 10a of the cartridge body 10. These ribs 10a and the film 80 define within the interior of the ink cartridge 1 a number of small chambers, for example, an ink reservoir chamber and a buffer chamber, to be discussed later.

A differential pressure regulating valve housing chamber 40a and a gas-liquid separation chamber 70a are formed at the back face side of the cartridge body 10 (FIG. 6). The differential pressure regulating valve housing chamber 40a houses a differential pressure regulating valve 40 that is composed of a valve member 41, a spring 42, and a spring seat 43. A dike 70b is formed on the inside wall that encloses the gas-liquid separation chamber 70a; and a gas-liquid separation membrane 71 is adhered to the dike 70b, with the structure as a whole constituting a gas-liquid separation filter 70.

Additionally, a number of grooves 10b are formed on the back end side of the cartridge body 10 (FIG. 6). When the outside surface film 55 is adhered to the cartridge body 10 so as to cover substantially the entire back face side thereof, these grooves 10b will define various passages, discussed later, between the cartridge body 10 and the outside surface film 55. The passages are for ink and air to flow through.

Next, the construction of the circuit board 34 mentioned above and surrounding area will be described. A sensor housing chamber 30a is formed at the lower face side of the left side face of the cartridge body 10 (FIG. 6). A remaining liquid level sensor module 31 and a fastening spring 32 are housed within the sensor housing chamber 30a. The fastening spring 32 presses the remaining liquid level sensor module 31 against the inside wall at the lower face side of the sensor housing chamber 30a, securing it in place. An opening on the right face side of the sensor housing chamber 30a is covered by a cover member 33, and the circuit board 34 mentioned above is fastened to the outside surface 33a of the cover member 33. The sensor housing chamber 30a, the remaining liquid level sensor module 31, the fastening spring 32, the cover member 33, the circuit board 34, and a sensor channel defining chamber 30b to be discussed later shall be referred to in toto as a sensor portion 30.

The circuit board 34 will be provided with a rewriteable nonvolatile memory such as EEPROM (Electronically Erasable and Programmable Read Only Memory), which records information such as the amount of ink consumption by the ink-jet printer.

On the lower face side of the cartridge body 10 there are provided, in addition to the liquid supply portion 50 and the open air hole 100 mentioned previously, a pressure release hole 110, the sensor channel defining chamber 30b, and a labyrinth channel defining chamber 95a (FIG. 6). The pressure release hole 110 is used to suck out air in order release pressure inside the ink cartridge 1 during injection of ink into the ink cartridge 1 in the manufacturing process. The sensor channel defining chamber 30b and the labyrinth channel defining chamber 95a define part of an ink reservoir portion, discussed later.

Immediately after manufacture of the ink cartridge 1, the liquid supply portion 50, the open air hole 100, the pressure release hole 110, and the labyrinth channel defining chamber 95a, and the sensor channel defining chamber 30b will have their openings respectively sealed off by sealing films 54, 90, 98, 95, 35. Of these, the sealing film 90 is intended to be peeled off by the user prior to installing the ink cartridge 1 in the carriage 6 of the ink-jet printer as described above. The open air hole 100 will thereby communicate with the outside, drawing air into the ink cartridge 1. The sealing film 54 is designed to be ruptured by the ink supply needle of the carriage 6 when the ink cartridge 1 is installed in the carriage 6 of the ink-jet printer.

Inside the liquid supply portion 50 there are housed, in order from the lower face side, a seal member 51, a spring seat 52, and a blocking spring 53. The seal member 51 provides a seal so that when an ink supply needle 66 is inserted into the liquid supply portion 50, no gap will form between the inside wall of the liquid supply portion 50 and the outside wall of the ink supply needle 66. The spring seat 52 is adapted to abut the inside wall of the seal member 51 and block off the liquid supply portion 50 when the ink cartridge 1 is not installed in the carriage 6. The blocking spring 53 urges the spring seat 52 in the direction of abutment against the inside wall of the seal member 51. When the ink supply needle is inserted into the liquid supply portion 50, the upper end of the ink supply needle will push the spring seat 52 upward, producing a gap between the spring seat 52 and the seal member 51 so that ink may be supplied to the ink supply needle through the gap.

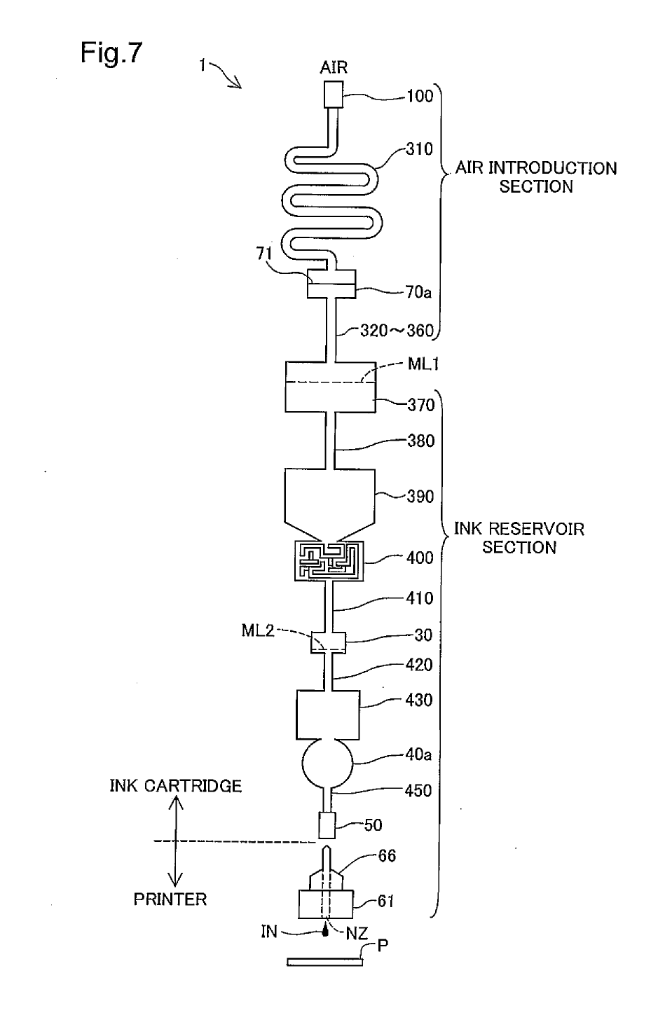

Next, in order to aid understanding, the pathway from the open air hole 100 to the liquid supply portion 50 will be described in conceptual terms with reference to FIG. 7. FIG. 7 is a conceptual depiction of the pathway leading from the open air hole to the liquid supply portion.

The pathway leading from the open air hole to the liquid supply portion is broadly divided into an air introduction section situated on the upstream side, and an ink reservoir section situated on the downstream side.

The air introduction section includes, in order from the upstream side, a serpentine path 310; the gas-liquid separation chamber 70a (which houses the aforementioned gas-liquid separation membrane 71); and connecting segments 320 to 360 that connect the gas-liquid separation chamber 70a with the ink reservoir section. The serpentine path 310 communicates at its upper end with the open air hole 100, and at its lower end with the gas-liquid separation chamber 70a. The serpentine path 310 has an elongated serpentine shape in order to lengthen the distance from the open air hole 100 to the first ink reservoir section. Moisture evaporation from the ink inside the ink reservoir section can be reduced thereby. The gas-liquid separation membrane 71 is composed of a material that allows gas to pass through but does not allow liquid to pass through. By situating the gas-liquid separation membrane 71 between the upstream side and the downstream side of the gas-liquid separation chamber 70a, ink backflowing in from the ink reservoir section can be prevented from advancing upstream beyond the gas-liquid separation chamber 70a.

The upstream side of the ink reservoir section includes a first ink reservoir chamber 370, a reservoir chamber connection path 380, and a second ink reservoir chamber 390, in that order. The upstream side of the reservoir chamber connection path 380 communicates with the first ink reservoir chamber 370, while the downstream side of the reservoir chamber connection path 380 communicates with second ink reservoir chamber 390.

The ink reservoir section additionally includes a labyrinth channel 400; a first flow channel 410; the aforementioned sensor portion 30; a second flow channel 420; a buffer chamber 430; the differential pressure regulating valve housing chamber 40a which houses the differential pressure regulating valve 40; and a third flow channel 450, in that order on the downstream side of the second ink reservoir chamber 390. The labyrinth channel 400 includes a space that is defined by the aforementioned labyrinth channel defining chamber 95a, and has three-dimensional labyrinthine shape. Through the labyrinth channel 400, air bubbles that have become entrained in the ink can be trapped so as to limit entrained air bubbles in the ink to the downstream side of the labyrinth channel 400. The first flow channel 410 communicates at its upper end to the labyrinth channel 400, and at its lower end communicates with the sensor channel defining chamber 30b of the sensor portion 30. The second flow channel 420 communicates at its upper end to the sensor channel defining chamber 30b of the sensor portion 30, and at its lower end to the buffer chamber 430. The buffer chamber 430 is a chamber adapted to store a prescribed amount of ink so that a prescribed amount of printing can take place even after there is no more ink in the sensor portion 30 and ink depletion has been detected. The buffer chamber 430 communicates with the differential pressure regulating valve housing chamber 40a. In the differential pressure regulating valve housing chamber 40a, the pressure regulating valve 40 adjusts the pressure of the ink to the downstream side of the differential pressure regulating valve housing chamber 40a to lower pressure than the ink on the upstream side, so that the ink on the downstream side goes to negative pressure. The third flow channel 450 communicates at its upper end with the differential pressure regulating valve housing chamber 40a, and at the lower end with the liquid supply portion 50.

The liquid supply portion 50 slips around the ink supply needle 66 which is situated on the upper face of the print head 61. The ink contained in the liquid supply portion 50 is then supplied to the print head 61 through the ink supply needle 66. Under the control of the main controller 2, the print head 61 ejects the ink supplied to it onto the paper P from nozzles NZ formed on its lower face.

During manufacture of the ink cartridge 1 it will be filled with ink up to the first ink reservoir chamber 370 which is situated at the uppermost location on upstream side of the ink reservoir section, i.e. to the liquid level shown conceptually by the broken line ML1 in FIG. 7. As the ink inside the ink cartridge 1 is consumed by the print head 61, the liquid will flow downstream, and consequently the liquid level will move toward the downstream side as well to be replaced by air inflowing into the ink reservoir section from upstream through the air introduction section. As the ink is progressively consumed, the liquid level will eventually reach the sensor portion 30, i.e. the level shown conceptually by the broken line ML2 in FIG. 7. At this point, air will enter the sensor portion 30, whereupon the remaining liquid level sensor module 31 will detect ink depletion. When ink depletion is detected, the ink cartridge 1 will halt printing before the ink present to the downstream side of the sensor portion 30 (in the buffer chamber 430 etc.) has been completely consumed, and will notify the user that the ink is depleted. The reason for doing so is that if the printing continues despite the ink being completely depleted, air may be drawn into the print head 61, possibly causing problems.

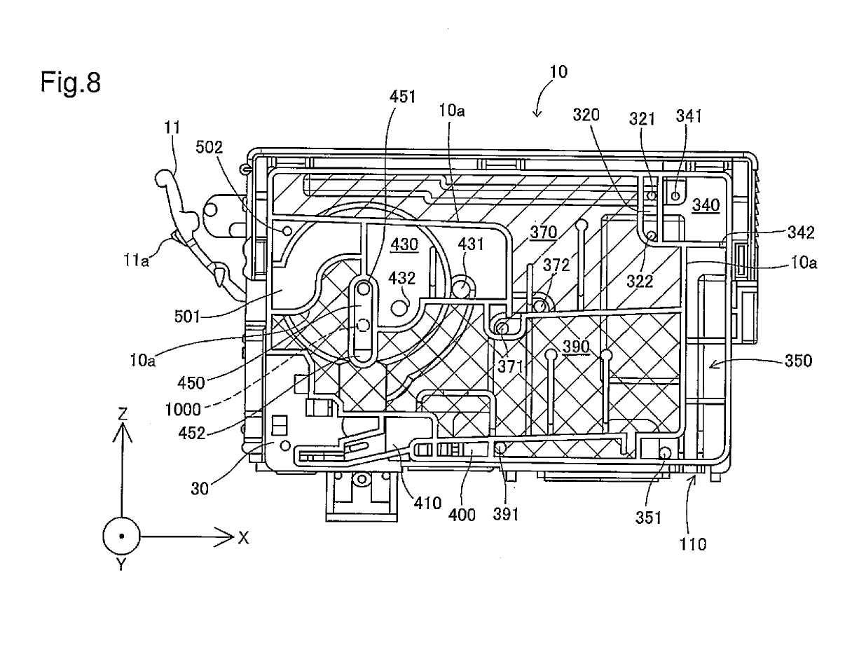

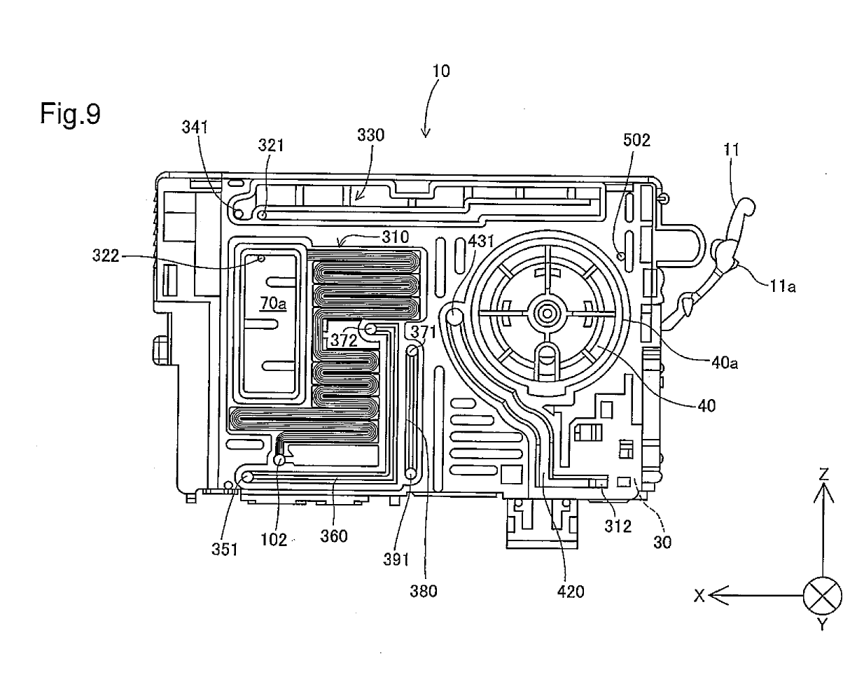

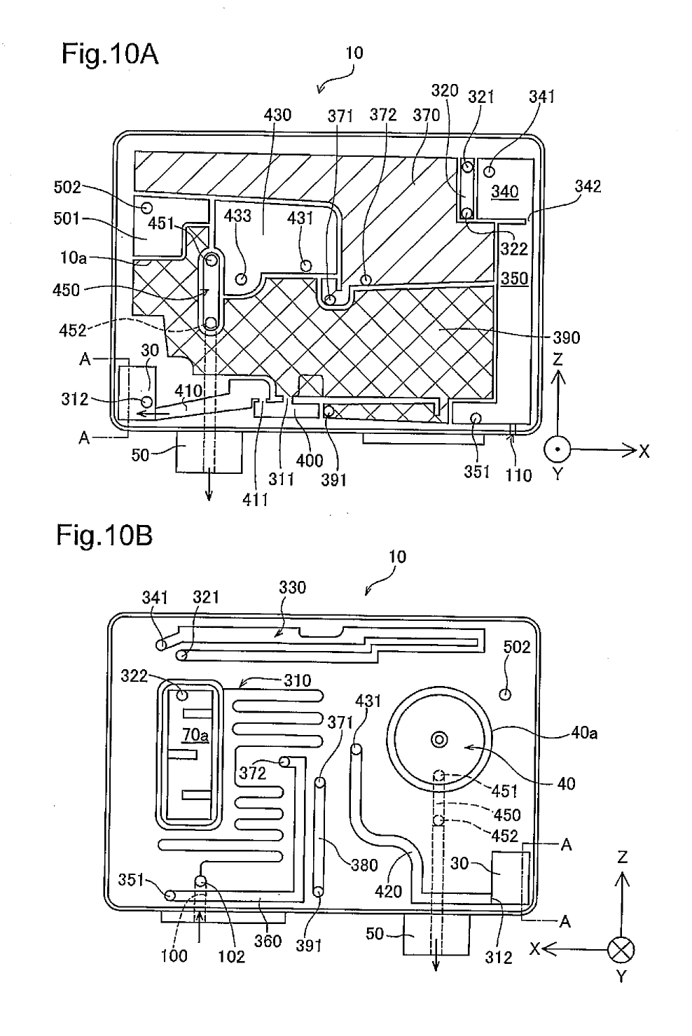

Building on the previous discussion, the specific configuration of the elements on the pathway from the open air hole 100 to the liquid supply portion 50 inside the ink cartridge 1 will be described with reference to FIGS. 8 to 10. FIG. 8 is a diagram of the cartridge body 10 viewed from the front. FIG. 9 is a diagram of the cartridge body 10 viewed from the back. FIG. 10A is simplified schematic of FIG. 8. FIG. 10B is simplified schematic of FIG. 9.

In the ink reservoir section, the first ink reservoir chamber 370 and the second ink reservoir chamber 390 are formed on the front face side of the cartridge body 10. In FIG. 8 and FIG. 10A, the first ink reservoir chamber 370 and the second ink reservoir chamber 390 are respectively shown by single hatching and cross hatching. The reservoir chamber connection path 380 is formed on the back face side of the cartridge body 10, at the location indicated in FIG. 9 and FIG. 10B. Communication hole 371 is a hole through which the upstream end of the reservoir chamber connection path 380 communicates with the first ink reservoir chamber 370; and communication hole 391 is a hole through which the downstream end of the reservoir chamber connection path 380 communicates with the second ink reservoir chamber 390.

In the air introduction section, the serpentine path 310 and the gas-liquid separation chamber 70a are respectively formed on the back face side of the cartridge body 10, at the locations shown in FIG. 9 and FIG. 10B. Communication hole 102 is a hole through which the upstream end of the serpentine path 310 and the open air hole 100 communicate. The downstream end of the serpentine path 310 passes through the side wall of the gas-liquid separation chamber 70a to communicate with the gas-liquid separation chamber 70a.

Turning now to a detailed description of the connecting segments 320 to 360 of the air introduction section shown in FIG. 7, these are composed of a first space 320, a third space 340, and a fourth space 350 (see FIG. 8 and FIG. 10A) that are situated on the front face side of the cartridge body 10; and a second space 330 and a fifth space 360 (see FIG. 9 and FIG. 10B) that are situated on the back face side of the cartridge body 10, with these spaces cascaded in order of their assigned symbols from the upstream end defining a single channel. Communication hole 322 is a hole through which the gas-liquid separation chamber 70a communicates with the first space 320. Communication holes 321 and 341 are respectively holes through which the first space 320 communicates with the second space 330, and the second space 330 communicates with the third space 340. The third space 340 and the fourth space 350 communicate through a notch 342 that is formed in the rib that divides the third space 340 and the fourth space 350. Communication holes 351 and 372 are respectively holes through which the fourth space 350 communicates with the fifth space 360, and the fifth space 360 communicates with the first ink reservoir chamber 370.

In the ink reservoir section, the labyrinth channel 400 and the first flow channel 410 are formed on the front face side of the cartridge body 10, at the locations shown in FIG. 8 and FIG. 10A. Communication hole 311 is disposed in the rib that divides the second ink reservoir chamber 390 and the labyrinth channel 400, and connects the second ink reservoir chamber 390 with the labyrinth channel 400. As discussed with reference to FIG. 6, the sensor portion 30 is situated on the lower face side of the left side face of the cartridge body 10 (FIGS. 8 to 10). The second flow channel 420 and the aforementioned gas-liquid separation chamber 70a are respectively formed on the back face side of the cartridge body 10, at the locations shown in FIG. 9 and FIG. 10B. The buffer chamber 430 and the third flow channel 450 are respectively formed on the front face side of the cartridge body 10, at the locations shown in FIG. 8 and FIG. 10A. Communication hole 312 is a hole through which the labyrinth channel defining chamber 95a (FIG. 6) of the sensor portion 30 communicates with the upstream end of the second flow channel 420; and communication hole 431 is a hole through which the downstream end of the second flow channel 420 communicates with the buffer chamber 430. Communication hole 432 is a hole through which the buffer chamber 430 communicates directly with the differential pressure regulating valve housing chamber 40a. Communication hole 451 and communication hole 452 are respectively holes through which the differential pressure regulating valve housing chamber 40a communicates with the third flow channel 450, and the third flow channel 450 communicates with the interior of the liquid supply portion 50.

Here, the space 501 shown in FIG. 8 and FIG. 10A is an unfilled chamber that is not filled with ink. The unfilled chamber 501 is not situated on the path leading from the open air hole 100 to the liquid supply portion 50, but rather is independent. An air communication hole 502 for communicating with the outside air is provided on the back face side of the unfilled chamber 501. The unfilled chamber 501 functions as an air expulsion chamber for accumulating negative pressure when the ink cartridge 1 is packaged in a vacuum pack. By so doing, with the ink cartridge 1 in packaged form, the pressure inside the cartridge body 10 will be maintained at or below a prescribed value so that it can supply ink containing negligible air in solution.

Configuration of Sensor Portion 30

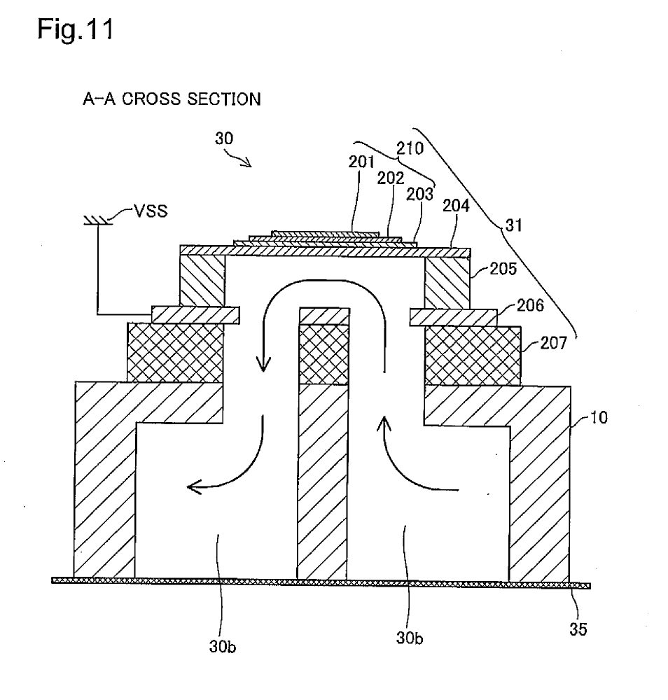

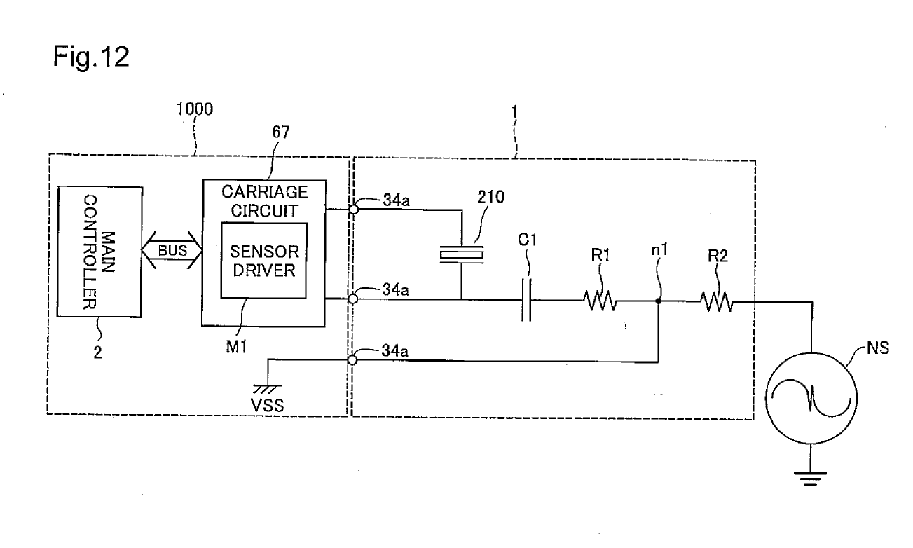

The configuration of the aforementioned sensor portion 30 will be described further with reference to FIG. 11 and FIG. 12. FIG. 11 is a diagram illustrating the configuration of the sensor portion in first embodiment. FIG. 11 shows the A-A cross section in FIG. 10. FIG. 12 is a diagram of the electrical configuration centered on a piezoelectric device that included in the sensor in first embodiment.

The aforementioned remaining liquid level sensor module 31 includes a piezoelectric device 210 constituting the sensor proper; an oscillator plate 204, a first base plate 205, a metal plate 206, and a second base plate 207. The piezoelectric device 210 includes an upper electrode 201, a piezoelectric layer 202 made of piezoelectric material such as lead zirconate titanate (PZT), and a lower electrode 203. The oscillator plate 204 transmits oscillation of the piezoelectric device 210 to the ink, and conversely transmits oscillation of the ink to the piezoelectric device 210. The oscillator plate 204 is an insulating thin film. The first base plate 205, the metal plate 206, and the second base plate 207 are plates having holes, and are stacked in that order. For the first base plate 205, ceramic produced by firing a green sheet could be used, for example. For the metal plate 206, a conductive metal such as stainless steel could be used, for example. For the second base plate 207, a resin could be used, for example. The oscillator plate 204 is positioned on the surface of the first base plate 205 so as to cover the holes in the first base plate 205; and the piezoelectric device 210 is positioned facing towards the hole of the first base plate 205, with the oscillator plate 204 therebetween. As a result, a cavity will be defined by the holes in the first base plate 205, the metal plate, and the second base plate 207. As depicted in FIG. 11, viewed in A-A cross section the cavity has a U-shape.

The remaining liquid level sensor module 31 is positioned above the sensor channel defining chamber 30b (FIG. 6) of the cartridge body 10, as depicted in FIG. 11. As a result, the cavity will define part of the ink reservoir section. In association with consumption of ink by the printer, the ink inside the ink cartridge 1 will flow through the interior of the U-shaped cavity as shown by the arrows in FIG. 11. As will be appreciated from the above description, if there is sufficient ink inside the ink cartridge 1, that is, if the interior of the cavity depicted in FIG. 11 is filled with ink, the conductive metal plate 206 will be in contact with the ink filing the interior of the cavity.

The U-shaped cavity (ink channel) will now be described more specifically. In the U-shaped channel, the segment along the oscillator plate 204 is designated as the first channel; the segment forming a generally right angle to the first channel at the upstream end of the first channel is designated as the second channel; and the segment forming a generally right angle to the first channel at the downstream end of the first channel is designated as the third channel. The piezoelectric device 210 is situated along the first channel. A portion of the inside face of the second channel and a portion of the inside face of the third channel are respectively defined by the conductive metal plate 206 (FIG. 11).

The electrical configuration of the ink cartridge 1 will now be discussed further making reference to FIG. 12. FIG. 12 depicts, in the form of an equivalent circuit, the electrical configuration of the ink cartridge 1 including the piezoelectric device 210. Resistance R1 and R2 represent resistance of the ink. Electrostatic capacitance C1 represents electrostatic capacitance produced between the ink and the lower electrode 203 of the piezoelectric device 210 that face one another to either side of the oscillator plate 204, which is an insulator. This electrostatic capacitance functions like a capacitor. Node n1 represents a node at which the ink contacts the metal plate 206, which is a conductor. As depicted in FIG. 12, the electrodes 201 and 203 of the piezoelectric device 210 are respectively electrically connected to one of the plurality of electrode terminals 34a of the circuit board 34. As a result, when the ink cartridge 1 is installed in the holder 62, the electrodes of the piezoelectric device 210 will be electrically connected to the carriage circuit 67 of the printer 1000. Additionally, as shown in FIG. 12, the conductive metal plate 206 will be electrically connected to the ground terminal among the plurality of electrode terminals 34a of the circuit board 34. As a result, when the ink cartridge 1 is installed in the holder 62, the metal plate 206 will be connected a stable fixed potential, namely, the frame ground VSS of the printer 1000. Accordingly, when the interior of the cavity is filled with ink, the ink will contact the metal plate 206, and will be connected to the frame ground VSS via the metal plate 206. The node n1 in FIG. 12 represents the contact point of the ink and the frame ground VSS (i.e. the contact point of the ink and the metal plate 206). In FIG. 12, the resistance R1 represents resistance of the ink present towards the piezoelectric device 210 side of the cavity from the metal plate 206, that is, between the metal plate 206 and the oscillator plate 204. In FIG. 12, resistance R2 represents resistance of the ink present on the opposite side of the piezoelectric device 210 viewed from the metal plate 206, e.g. the ink present in the first ink reservoir chamber 370, the second ink reservoir chamber 390, and the buffer chamber 430.

In FIG. 12, the AC power supply (noise source) indicated by the symbol NS conceptually depicts noise propagated to the ink inside the ink cartridge 1 from the outside

Next, detection of the remaining ink level using the sensor will be discussed. In the printer 1000, the main controller 2 and the carriage circuit 67 are designed so as to be able to exchange signals via a bus. The carriage circuit 67 has a sensor driver M1 as a function block. The main controller 2 and the sensor driver M1 of the carriage circuit 67 cooperate to carry out a process to detect the remaining ink level in each of the ink cartridges 1 (remaining ink level detection process). Specifically, when the main controller 2 initiates the remaining ink level detection process, it will send to the sensor driver M1 a command requesting frequency measurement for the purpose of determining remaining ink level (discussed later), and data identifying the ink cartridge 1 that is to be targeted for the frequency measurement. Upon receiving the command and the data, the sensor driver M1 will initiate a frequency identification process on the targeted ink cartridge 1. Specifically, the sensor driver M1 will connect, via the corresponding electrode terminal 34a, either the upper electrode 201 or the lower electrode 203 of the piezoelectric device 210 to a sensor drive signal line that issues a sensor drive signal DS. The sensor driver M1 will also connect, via the corresponding electrode terminal 34a, the other of the upper electrode 201 or the lower electrode 203 to the frame ground VSS. Once the electrodes 201 and 203 of the piezoelectric device 210 have been connected to the sensor drive signal line or to the frame ground VSS, the sensor drive signal DS will be applied to the corresponding electrode of the piezoelectric device 210 via the sensor drive signal line. The sensor drive signal DS is a signal containing one or more trapezoidal pulses, for example.

When the sensor drive signal DS is applied to an electrode of the piezoelectric device 210, strain (expansion and contraction) will be produced in the piezoelectric device 210. Coincident with the timing of completion of application of the sensor drive signal DS (trapezoidal pulse), the sensor driver M1 will disconnect the sensor drive signal line from the electrode of the piezoelectric device 210 to which the signal line was connected. Thereupon, the piezoelectric device 210 will oscillate (expand and contract) in a manner dependent on the remaining ink level, and the piezoelectric device 210 will output a voltage dependent on its oscillation (a response signal RS) from the electrode that was disconnected from the sensor drive signal line to the carriage circuit 67, via the electrode terminal 34a. The sensor driver M1 of the carriage circuit 67 will then measure the frequency of the response signal RS.

Once the sensor driver M1 measures the frequency of the response signal RS, the measurement result will be transmitted to the main controller 2. On the basis of the measurement result it has received from the sensor driver M1, the main controller 2 will determine the remaining ink level for the ink cartridge 1 that was targeted for the process. For example, if the remaining ink level is equal to or greater than a prescribed level, the piezoelectric device 210 will oscillate at a first characteristic oscillation frequency H1 (e.g. approximately 30 KHz), whereas if the remaining ink level is less than the prescribed level, the piezoelectric device 210 will oscillate at a second characteristic oscillation frequency H2 (e.g. approximately 110 KHz). Specifically, where the remaining ink level is equal to or greater than the prescribed level, the cavity facing the piezoelectric device 210 with the oscillator plate 204 therebetween will be filled with ink, whereas if the remaining ink level has fallen to below the prescribed level, the cavity facing the piezoelectric device 210 with the oscillator plate 204 therebetween will not contain ink, only air. The resonance frequency of the piezoelectric device 210 will differ to reflect such different conditions around the piezoelectric device 210. If the frequency measurement result it has received is substantially equal to the first characteristic oscillation frequency HI, the main controller 2 will decide that the remaining ink level is equal to or greater than the prescribed level, whereas if the result is substantially equal to the second characteristic oscillation frequency H2, it will decide that the remaining ink level is less than the prescribed level.

According to first embodiment described above, a fixed stable potential, namely the frame ground VSS potential, will be applied to the ink inside the ink cartridge 1 through the medium of the metal plate 206. As a result, interference with the piezoelectric device 210 by outside noise with through the medium of the conductive ink can be limited. As a result, accuracy can be improved during detection of remaining ink level using the piezoelectric device 210 as the electrical sensor.

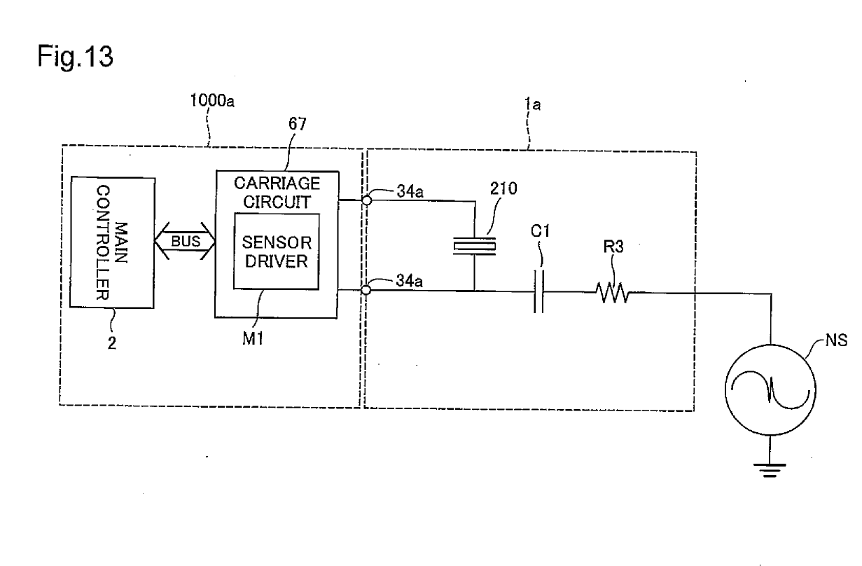

In order to aid understanding, a comparative example illustrative of the case where the ink is not connected to a stable potential will be described with reference to FIG. 13. FIG. 13 is a diagram of an electrical configuration centered on a piezoelectric device that constitutes the sensor in the comparative example. In FIG. 13, of the elements of the printer 1000a and the ink cartridge 1a of the comparative example, those elements that have been assigned like symbols to FIG. 12 are identical to the elements assigned like symbols that were discussed in FIG. 12 and require no further description. In the ink cartridge 1a of the comparative example, resistance R3 represents resistance of the conductive ink. In the comparative example, the part corresponding to resistance R3, i.e. the conductive ink, functions as an antenna, receiving noise from the outside noise source NS and transmitting it to the piezoelectric device 210. As a result, there is a risk of the piezoelectric device 210 oscillating due to the effects of the noise. There is also a risk that AC noise will be propagated to the carriage circuit 67. As a result, there is a risk that the accuracy of detection of remaining ink level by the piezoelectric device 210 will be adversely affected. In first embodiment, interference by such outside noise is limited.

Furthermore, as will be appreciated from FIG. 11, the metal plate 206 is situated in proximity to the piezoelectric device 210. That is, the ink is connected to the frame ground VSS in the vicinity of the piezoelectric device 210. As a result, interference by outside noise can be limited more effectively. When the location at which ink is connected to a stable potential is situated away from the piezoelectric device 210, the ink in a zone extending from the contact point with the stable potential to the piezoelectric device 210 will tend to function as an antenna and can pick up noise, making it preferable for the ink to be connected to a stable potential in vicinity of the piezoelectric device 210.

Furthermore, because a fixed potential is applied to the ink, the ink itself will act as a shield so that interference of extraneous noise with the piezoelectric device 210 can be limited.

Additionally, as will be appreciated from FIG. 11, the metal plate 206 defines part of the upstream side and the downstream side of the U-shaped passage as discussed above. That is, the metal plate 206 is situated to both the upstream side and the downstream side of the location at which the ink faces the piezoelectric device 210 with the oscillator plate 204 therebetween (the aforementioned first channel). As a result, the ink will be connected to the frame ground VSS at both the upstream side and the downstream side of the ink flowing in the vicinity of the piezoelectric device 210. As a result, interference of extraneous noise with the piezoelectric device 210 can be limited more effectively.

Furthermore, since the metal plate is a component that functions as a seat for the purpose of ensuring rigidity in the vicinity of the piezoelectric device 210 and of limiting attenuation of oscillation of the piezoelectric device 210, an increase in the number of parts needed solely to connect the ink the frame ground VSS can be avoided.

### Variations of First Embodiment

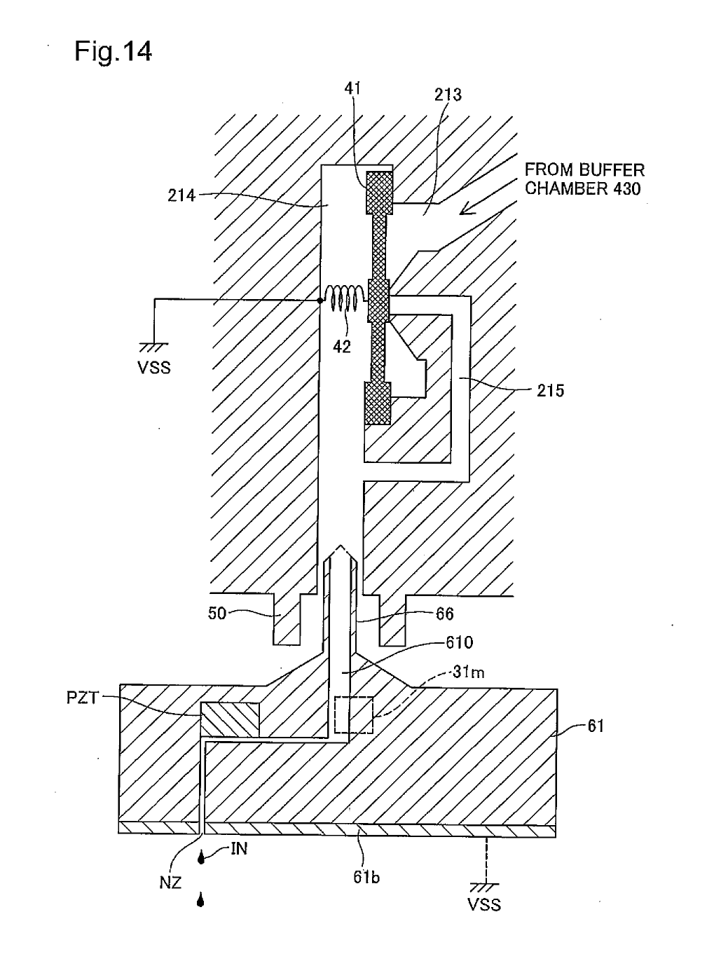

The location at which the conductive ink is electrically connected to the frame ground VSS is not limited to a section of the metal plate 206 as taught in first embodiment. A variation by way of another example will be described with reference to FIG. 14. FIG. 14 is a diagram depicting a simplified cross section of construction in an area from the vicinity of the differential pressure regulating valve 40 to the liquid supply portion 50, shown together with a simplified cross section of the print head 61. In FIG. 14, for convenience in description the structural details have been omitted in order to aid understanding; only concise simplified structures are depicted. The ink reservoir section is divided into an upstream channel 213 and a downstream channel 214 by the valve member 41 of the differential pressure regulating valve 40. The upstream channel 213 is a section that corresponds to the upstream side of the differential pressure regulating valve housing chamber 40a depicted in FIGS. 6 and 7. The downstream channel 214 is a channel that leads to the liquid supply portion 50, and is composed of the downstream side of the aforementioned differential pressure regulating valve housing chamber 40a, and the third flow channel 450 depicted in FIG. 7. Both the upstream channel 213 and the downstream channel 214 actual have more complex construction.

The valve member 41 is urged by the spring 42 towards the valve seat (the left side in FIG. 14) which has been formed on the wall face on the opposite side from the spring 42. A bypass channel 215 that communicates at a first end with the downstream channel 214 and that communicates at a second end with the wall face defining the valve seat is also provided. When the sum of ink pressure inside the downstream channel 214 and the force produced by the spring 42 exceeds the ink pressure inside the upstream channel 213, the valve member 41 will push against the valve seat and assume the closed position. In this state, the upstream channel 213 and the downstream channel 214 are physically separated so that ink cannot flow from the upstream channel 213 into the downstream channel 214.

On the other hand, when the ink in the downstream channel 214 has been consumed, and the sum of ink pressure inside the downstream channel 214 and the force of the spring 42 is now lower than the ink pressure inside the upstream channel 213, a gap will open up between the valve member 41 and the valve seat. As a result, the upstream channel 213 will communicate with the bypass channel 215, and ink will flow from the upstream channel 213 and into the downstream channel 214 via the bypass channel 215. This inflow of ink will continue until the sum of ink pressure inside the downstream channel 214 and the force of the spring 42 again counterbalances the pressure inside the upstream channel 213. When the sum of ink pressure inside the downstream channel 214 and the force of the spring 42 counterbalances the pressure inside the upstream channel 213, the valve member 41 will push against the valve seat, obstructing communication between the upstream channel 213 and the bypass channel 215 so that the upstream channel 213 and the bypass channel 215 are physically separated. Through this design, the ink pressure inside the downstream channel 214 will be constantly maintained at a lower level than the ink pressure inside the upstream channel 213.

In the first variation, the valve member 41 is formed from an electrical conductor. The electrical conductor of the valve member 41 could be conductive rubber, a conductive elastomer, or other conductive resin for example. Also, in the first variation, the spring 42 that contacts the valve member 41 is also formed from an electrical conductor. The electrical conductor of the spring 42 could be stainless steel for example. A wire is connected to the spring 42, electrically connecting the spring 42 to the ground terminal among the plurality of electrode terminals 34a of the circuit board 34. As a result, when the ink cartridge 1 has been installed in the holder 62, the valve member 41 will be connected to the frame ground VSS in the printer 1000, which is a stable fixed potential (the solid line in FIG. 14). When the upstream channel 213 is filled with ink, the ink will be electrically connected to the frame ground VSS via the valve member 41 and the spring 42.

The above configuration affords working effects comparable to first embodiment. Also, since the valve member 41 and the spring 42 are components that are needed anyway in to bring the ink in proximity to the liquid supply portion 50 to negative pressure, an increase in the number of parts needed merely to connect the ink the frame ground VSS can be avoided.

In a second variation, as in the first variation, the valve member 41 is formed from an electrical conductor. Meanwhile, in the second variation, the spring is not connected to the frame ground VSS. Instead, the ink is electrically connected to the frame ground VSS via the print head 61.

Here, the ink supply needle 66 that pierces the liquid supply portion 50 of the ink cartridge 1 is disposed upright on the upper face of the print head 61. The print head 61 is provided on its lower face with a nozzle plate 61b composed of a conductor such as aluminum or stainless steel, and having a multitude of nozzles NZ. The nozzle plate 61b is connected to the frame ground VSS through a wire (the broken line in FIG. 14). In the interior of the print head 61 there is formed an internal channel 610 that at one end opens out from the distal end of the ink supply needle 66, and at the other end opens into a nozzle. The ink inside the ink cartridge 1 will flow from the end on the ink supply needle 66 side and through the internal channel 610, to be ejected from the nozzle. However, as the ink on the downstream side of the valve member 41 is at negative pressure due to aforementioned valve member 41 and spring 42, the ink will not be ejected automatically from the nozzle hole. A piezoelectric element PZT is disposed midway along the wall of the internal channel 610. Under the control of the main controller 2, this piezoelectric element PZT will expand, producing compressive deformation of the internal channel 610 and thereby causing an ink drop IN to be ejected from the nozzle hole. Instead of such a system whereby ink is ejected using piezoelectric elements, it would be possible to employ a method whereby ink drops are ejected through the action of bubbles produced in the internal channel 610 by a heater installed within the internal channel 610.

The downstream side from the cavity where the piezoelectric device 210 is situated is filled with ink up to the upstream channel 213 in FIG. 14. The ink path from the downstream channel 214 to the nozzle NZ is also filled with ink. The ink inside the upstream channel 213 and the ink inside the downstream channel 214 are electrically connected by the valve member 41, which is a conductor. The ink in the section furthest downstream inside the downstream channel 214 contacts the nozzle plate 61b, and is connected to the frame ground VSS via the nozzle plate 61b. As a result, the ink the cavity in proximity to the piezoelectric device 210 will be electrically connected to the frame ground VSS (which is a stable fixed potential) via the valve member 41 and the nozzle plate 61b.

The above configuration also affords working effects comparable to first embodiment. Also, since the valve member 41 and the nozzle plate 61b are already necessary components of the ink cartridge 1 and the printer 1000, an increase in the number of parts needed merely to connect the ink the frame ground VSS can be avoided.

The method by which the ink is electrically connected to the frame ground VSS via the print head 61 is not limited to one of connecting it to the frame ground VSS via the nozzle plate 61b. Any of various components that contact the ink in the print head 61 could be fabricated from conductive material, and the conductive member in question electrically connected to the frame ground VSS. For example, the ink supply needle 66 in its entirety, or a portion thereof, specifically, the distal end that contacts the ink or section in proximity to the distal end of the ink supply needle 66 could be made of conductive material. The conductive section would then be electrically connected to the frame ground VSS through a wire. Alternatively, a cap made of conductive material could be installed in the opening through which the ink in the distal end section of the ink supply needle 66 is introduced into the internal channel 610. The cap will have an opening to allow ink to be drawn into the internal channel 610. The cap would then be electrically connected to the frame ground VSS through a wire.

As shown by the first and second variations described above, the location for electrical connection to the frame ground VSS is not limited to the metal plate 206 as was shown in first embodiment. That is, it is sufficient for at least part of the inside face contacting the ink in the ink reservoir section to be formed from a conductor, with the conductor being connected to the frame ground VSS.

### B. Second Embodiment

Printer and Ink Cartridge Configuration:

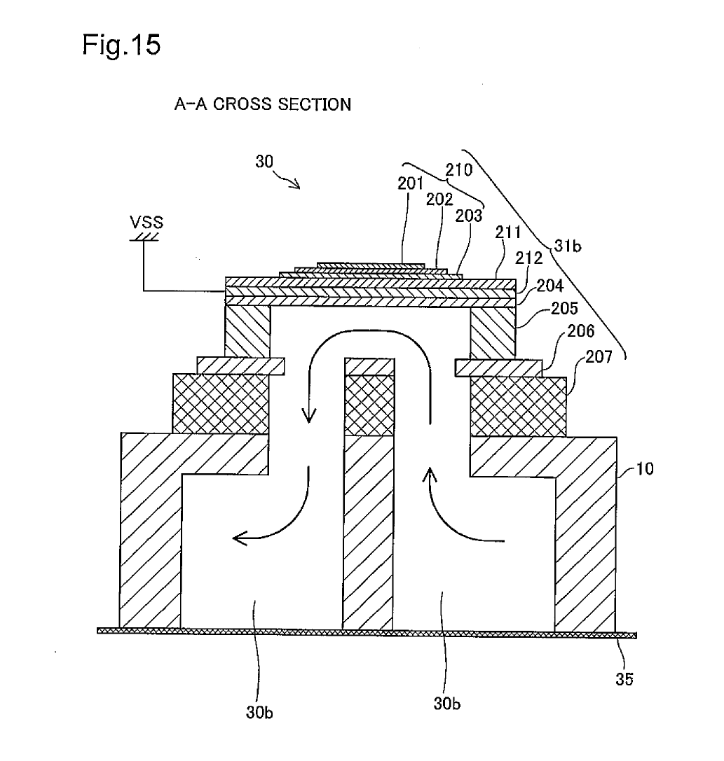

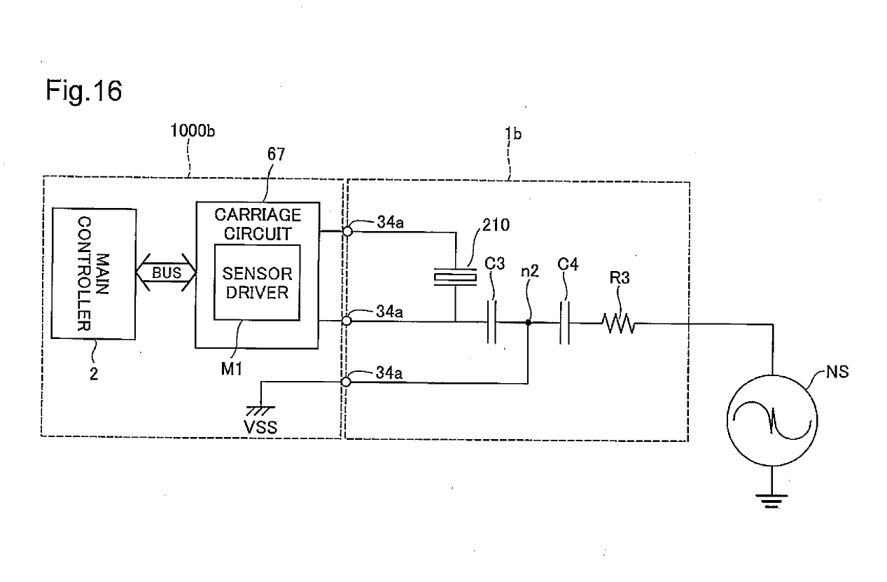

A second embodiment will be described with reference to FIG. 15 and FIG. 16. FIG. 15 is a diagram illustrating the configuration of the sensor portion in second embodiment. FIG. 15 shows the A-A cross section in FIG. 10. FIG. 16 is a diagram of the electrical configuration centered on a piezoelectric device that constitutes the sensor in second embodiment.

The simplified configurations of the printer 1000b and the ink cartridge 1b in second embodiment are the same as those of the printer 1000 and the ink cartridge 1 in first embodiment described previously with reference to FIGS. 1 to 10, and thus require no further description; in the following discussion, like elements will be assigned like symbols.

The ink cartridge 1b of second embodiment differs from the ink cartridge 1 of first embodiment 1 in terms of the configuration of the sensor portion. As depicted in FIG. 15, the sensor portion 30 of second embodiment is provided with a remaining liquid level sensor module 31b in place of the remaining liquid level sensor module 31 of first embodiment.

The remaining liquid level sensor module 31b of second embodiment is provided with a thin insulating film 211 and a thin conducting film 212, in addition to a piezoelectric device 210, an oscillator plate 204, a first base plate 205, a metal plate 206, and a second base plate 208 comparable to those in first embodiment. The thin insulating film 211 and the thin conducting film 212 are positioned between the piezoelectric device 210 and the oscillator plate 204. The thin insulating film 211 is positioned towards the piezoelectric device 210 side, and the thin conducting film 212 is positioned towards the oscillator plate 204 side. The configuration of the remaining liquid level sensor module 31b of second embodiment is otherwise the same as the remaining liquid level sensor module 31 of first embodiment, and requires no description. An insulating layer (the thin insulating film 211), a conducting layer (the thin conducting film 212), and an insulating layer (the oscillator plate 204) are stacked between the ink from the piezoelectric device 210 in that order, going towards the ink. As depicted in FIG. 16, the thin conducting film 212 is connected to the ground terminal among the plurality of electrode terminals of the circuit board 34. As a result, when the ink cartridge 1b is installed in the holder 62, the thin conducting film 212 will be connected to a stable fixed potential in the printer 1000b, namely, to the frame ground VSS.

The electrical configuration of the ink cartridge 1b will be discussed further with reference to FIG. 16. FIG. 16 depicts, in the form of an equivalent circuit, the electrical configuration of the ink cartridge 1b including the piezoelectric device 210. As in FIG. 13, resistance R3 represents resistance of the ink. Electrostatic capacitance C3 represents electrostatic capacitance produced by the thin conducting film 212 and the lower electrode 203 of the piezoelectric device 210 that face one another to either side of the thin insulating film 211. Electrostatic capacitance C4 represents electrostatic capacitance produced by the ink and the thin conducting film 212 that face one another to either side of the oscillator plate 204, which is an insulator. Node n2 corresponds to the thin conducting film 212, and show that the thin conducting film 212 is connected to the frame ground VSS via an electrode terminal 34a.

According to second embodiment described above, in the cavity of the remaining ink level sensor module 31b, the ink is AC connected via electrostatic capacitance C4 to the frame ground VSS, which is a stable potential. As a result, interference with the piezoelectric device 210 by the AC component of the electrostatic capacitance C4 through the medium of the conductive ink can be limited. As a result, the sensing accuracy of the piezoelectric device 210 when used as an electrical sensor for detecting remaining ink level can be improved, for example.

Manufacture of the remaining ink level sensor module 31b is relatively simple, since it involve simply increasing the number of layers in the stack by two.

Furthermore, since the thin conducting film 212 does not come into direct contact with the ink, it is not necessary to consider the ink resistance (resistance to corrosion by ink, etc.) of the thin conducting film 212, and inexpensive materials may be used. The risk of ink leakage due to corrosion of the thin conducting film 212 is also eliminated.

### Variations of Second Embodiment:

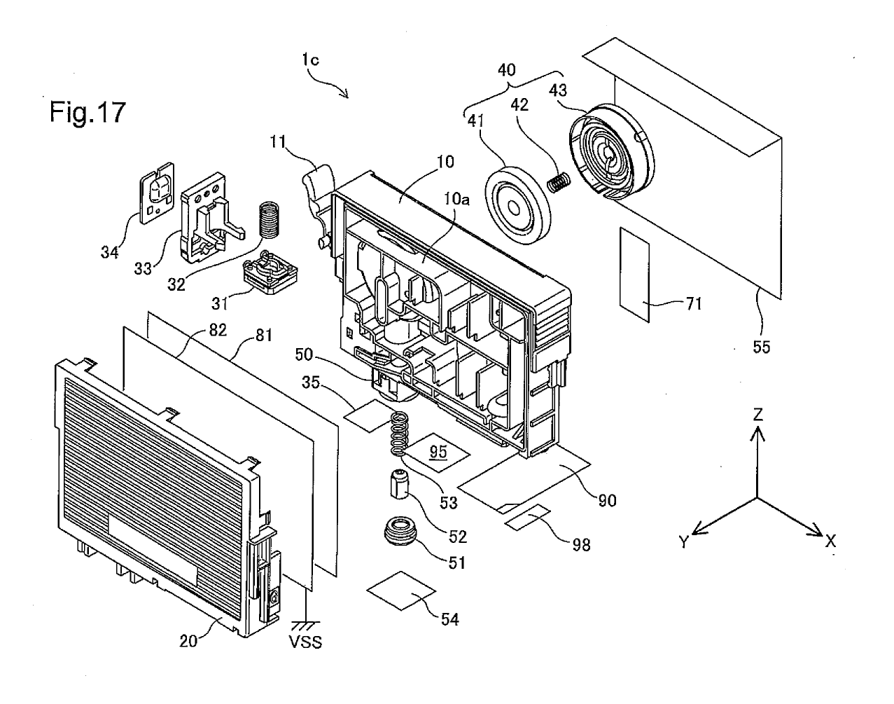

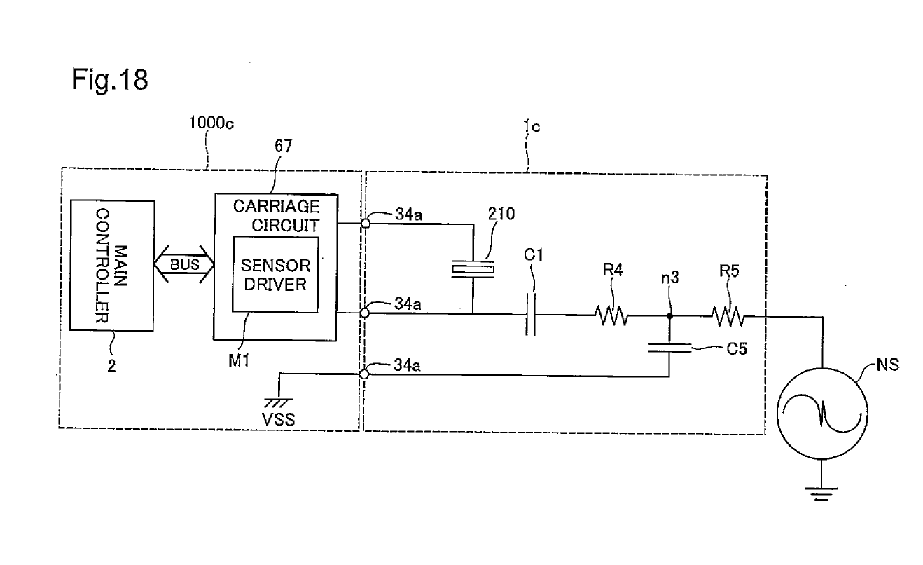

The location at which the ink is electrically connected to the frame ground VSS with electrostatic capacitance therebetween is not limited to the vicinity of the remaining ink level sensor module 31b as taught in second embodiment. A variation by way of another example will be described with reference to FIGS. 17 and 18. FIG. 17 is an exploded perspective view of an ink cartridge in a variation of second embodiment. FIG. 18 is a diagram of the electrical configuration centered on a piezoelectric device that constitutes the sensor in the variation of second embodiment. The ink cartridge 1c of the variation depicted in FIG. 17 differs from the ink cartridge 1 of first embodiment 1 depicted in FIG. 5 in that the front face side of the cartridge body 10 is covered by a film. In the ink cartridge 1 of first embodiment 1, a single film 80 is adhered to the edge faces of the front end side of the ribs 10a of the cartridge body 10 (FIG. 5). On the other hand, in this variation, one insulating film 81 is adhered to the edge faces of the front end side of the ribs 10a of the cartridge body 10, and additionally a conducting film 82 of approximately the same size is then placed on and adhered to the insulating film 81. That is, the wall of the ink cartridge 1 is formed by the insulating film 81 and the conducting film 82, with the insulating film 81 situated on the side of the wall that contacts the ink (the inner side) and the conducting film 82 situated on the side opposite the ink (the outer side). For the insulating film 81, an insulating resin film could be used, for example. For the conducting film 82, aluminum foil could be used, for example.

The electrical configuration of the ink cartridge 1c will now be discussed further making reference to FIG. 18. FIG. 18 depicts, in the form of an equivalent circuit, the electrical configuration of the ink cartridge 1c including the piezoelectric device 210. Resistance R4 and R5 represent resistance of the ink. Electrostatic capacitance C1 represents electrostatic capacitance produced by the ink and the lower electrode 203 of the piezoelectric device 210 that face one another to either side of the oscillator plate 204, which is an insulator. Electrostatic capacitance C5 represents electrostatic capacitance produced by the ink and the conductive film 82 that face one another to either side of the insulating film 81. As shown by the equivalent circuit, the ink resistance R4 and R5, and the electrostatic capacitance C5, branch at a node n3 and have a mutually parallel relationship. As depicted in FIG. 18, the conductive film 82 is electrically connected to one of the plurality of electrode terminals of the circuit board 34. As a result, when the ink cartridge 1c has been installed in the holder 62, the conductive film 82 will be electrically connected to the frame ground VSS of the printer 1000c.

According to the variation described above, since the electrostatic capacitance C5 will absorb extraneous noise, interference of the AC component of extraneous noise with the piezoelectric device 210 through the medium of the conductive ink can be limited. As a result, where for example the piezoelectric device 210 is used as an electrical sensor to detect remaining ink level accuracy can be improved.

Furthermore, in this variation, the conducting film 82 and the insulating film 81 that form the electrostatic capacitance CS constitute the wall corresponding to one face of the ink cartridge 1c, which is a hollow, generally rectangular parallelepiped. As a result, as depicted in FIG. 17, the insulating film 81 and the conducting film 82 substantially cover a parallel projection plane of the ink inside the ink cartridge 1c viewed from the Y axis direction (FIG. 17). Accordingly, AC noise interfering with the ink can be efficiently absorbed from the ink as a whole.

For the conducting film 82 and the insulating film 81, a ready-made aluminum laminate composed of aluminum foil and an insulating resin film could be used as well.

In this variation, one entire face of the generally rectangular parallelepiped ink cartridge 1c is covered by the conducting film 82 and the insulating film 81; however, it is not necessary for the entire face to be covered, and it would be acceptable to cover only a portion.

### C. Other Variations

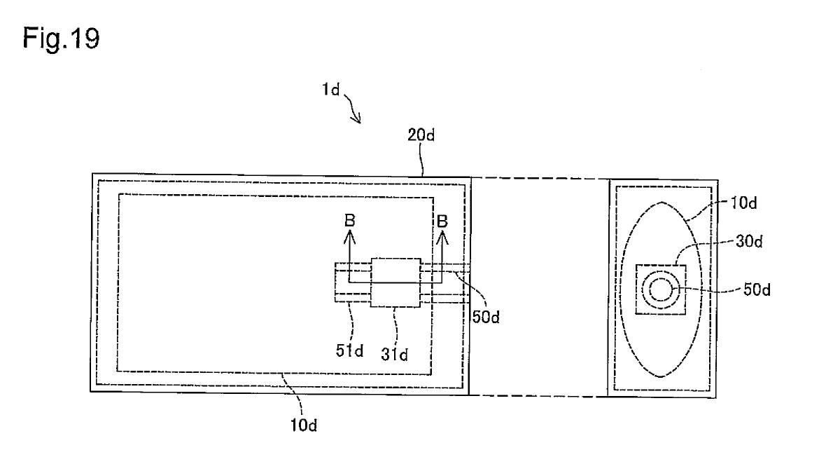

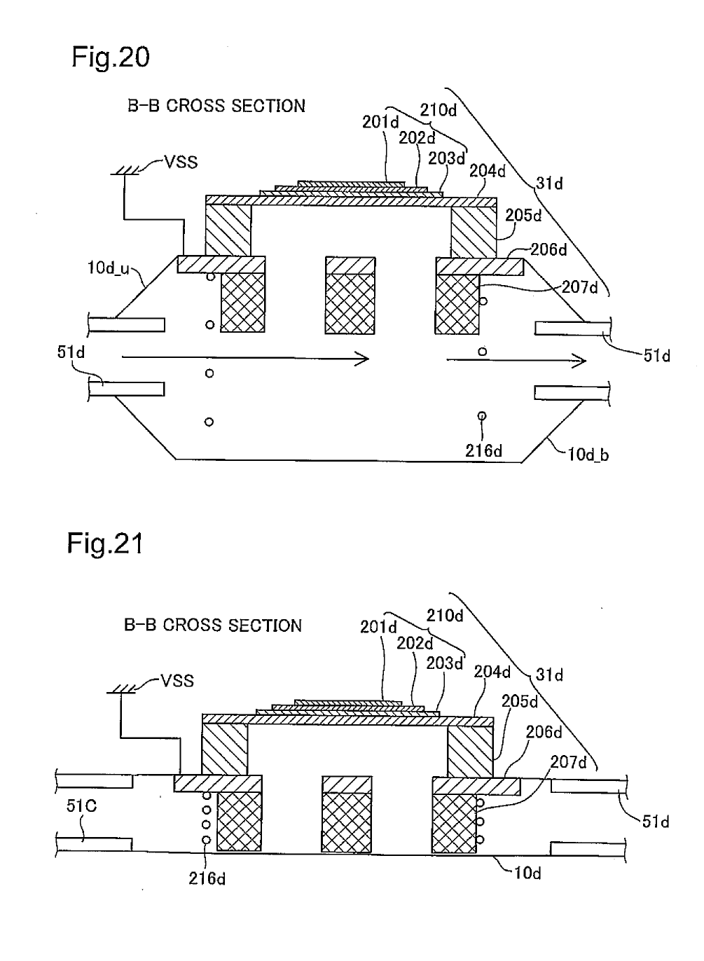

(1) In the preceding embodiments and their variations, ink cartridges of open-air design whereby air is drawn into the ink reservoir section as the ink is consumed were employed; however, the present invention is not limited to being implemented in such designs. The invention could be implemented analogously, for example, in ink cartridges of hermetic design in which the ink is contained in a sealed container, with the container shrinking as the ink is consumed. An example of an ink cartridge of hermetic design will be described with reference to FIGS. 19 to 21. FIG. 19 depicts a hermetic type ink cartridge in front view and in side view. FIG. 20 is a first diagram depicting the B-B cross section in FIG. 19. FIG. 21 is a second diagram depicting the B-B cross section in FIG. 19. FIG. 20 depicts a cross section in the case where the remaining ink level in the ink cartridge 1d is greater than a prescribed level; and FIG. 21 depicts a cross section in the case where the remaining ink level in the ink cartridge 1d is less than a prescribed level.

As depicted in FIG. 19, the ink cartridge 1d includes a generally rectangular parallelepiped hollow housing 20d; an ink pack 10d housed inside the housing 20d; an ink supply tube 51d; and a remaining ink level sensor module 31d. The housing 20d is made of resin, for example. The ink pack 10d is constructed in pouch form by joining together two pliable, generally rectangular synthetic resin films 10d_{—}u and 10d_{—}b. The interior of the ink pack 10d is filled with conductive ink. The ink supply tube 51d is affixed to one face of the housing, with the other end of the ink supply tube 51d exposed to the outside. An ink supply hole 50d opens at the outside end of the ink supply tube 51d.

When the ink cartridge 1d is installed in a printer (not shown), the ink supply needle which communicates with the print head of the printer will slip into the ink supply hole 50d of the ink cartridge 1d. In response to ejection of ink from the nozzle by a piezo element inside the print head of the printer, the ink will pass from the ink pack 10d and through the ink supply tube 51d, to be supplied to the print head from the ink supply hole 50d.

The remaining ink level sensor module 31d is situated midway along the ink supply tube 51d. Like the remaining ink level sensor module 31 in first embodiment, the remaining ink level sensor module 31d is used to determine whether the remaining level of ink stored in the ink cartridge 1d is above a prescribed level, or below the prescribed level.

As in first embodiment, the remaining ink level sensor module 31d includes a piezoelectric device 210 that includes an upper electrode 201d, a piezoelectric layer 202d, and a lower electrode 203d. Also, as in first embodiment, the remaining ink level sensor module 31d is additionally furnished with an oscillator plate 204d, a first base plate 205d, a metal plate 206d, and a second base plate 207d. These constituent elements 210d and 204d-206d are stacked in the same order as in the remaining ink level sensor module 31 in first embodiment. Moreover, like the metal plate 206 (FIG. 11) of first embodiment, with the ink cartridge 1 installed in the printer the metal plate 206 is electrically connected to the frame ground VSS of the printer.

The remaining ink level sensor module 31d is connected to an upper film 10d_{—}u that makes up the pouch-shaped ink pack 10d. A spring 216d is disposed between the remaining ink level sensor module 31d and the lower film 10d_{—}b that makes up the ink pack 10d. The spring 216d applies stress to the remaining ink level sensor module 31d and to the lower film 10d_{—}b, in the direction of expansion of the space between the remaining ink level sensor module 31d and the lower film 10d_{—}b.

If the remaining ink level in the ink pack 10d is greater than a prescribed level, the ink pack 10d will be pushed and spread out by the spring 216d, thereby forming a relatively wide space filled with ink below the piezoelectric device 210d as depicted in FIG. 20. On the other hand, if the remaining ink level in the ink pack 10d is less than a prescribed level, the ink pack 10d, the spring 216d will be compressed due to compression of the spring 216d, thereby forming a relatively narrow space filled with ink below the piezoelectric device 210d as depicted in FIG. 21.

Detection of remaining ink level in the ink cartridge 1d of hermetic design will now be described. Like the ink cartridges of open-air design described in the preceding embodiments, a sensor drive signal DS is applied to the piezoelectric device 210d from the printer end. Thereupon, as in the ink cartridges of open-air design, the piezoelectric device 210d will oscillate (expand and contract) in a manner dependent on the remaining ink level and will output an oscillation-dependent voltage (response signal RS) to the printer. At this point, in the ink cartridge of open-air design, the frequency of the response signal RS would be measured to determine the remaining ink level; in the hermetic ink cartridge, however, the remaining ink level is determined by measuring the magnitude of the amplitude of the response signal RS. Specifically, if the remaining ink level is above the prescribed level i.e. if a relatively wide space filled with ink is formed below the piezoelectric device 210d, the amplitude of the response signal RS will be greater. Conversely, if the remaining ink level is below the prescribed level, i.e. if a relatively narrow space filled with ink is formed below the piezoelectric device 210d, the amplitude of the response signal RS will be smaller. Accordingly, if the amplitude of the response signal RS is greater than a prescribed value, it will be determined that the remaining ink level in the ink pack 10d is above the prescribed level, whereas if the amplitude of the response signal RS is less than a prescribed value, it will be determined that the remaining ink level in the ink pack 10d is below the prescribed level.

In the ink cartridge 1d of the variation described above, the ink inside the ink cartridge 1d is electrically connected to the frame ground VSS via the metal plate 206. As a result, the ink cartridge 1d of the variation affords working effects comparable to first embodiment.

(2) In the above embodiments and variations, the piezoelectric device used as the sensor is disposed in the ink cartridge; however, it would also be acceptable to dispose it on the printer end, for example, along the ink channel that leads to the nozzle in the interior of the print head of the printer. Specifically, like the remaining ink level sensor module 31m shown by the broken lines in FIG. 14, the sensor could be situated on the internal channel 610 that leads from the ink supply needle 66 to the nozzle NZ in the print head 61, for example. In this way, the sensor may be disposed in a part of the space which leads from the ink cartridge interior and ink supply needle to the nozzle and in which ink is present.

(3) In the above embodiments and variations, the ink cartridge is detachably installed in the printer; however, an ink tank that is affixed to the printer could be used instead.

(4) In the preceding embodiments, an ink-jet printer and an ink cartridge for ink-jet printer use were employed, but it would be possible to instead employ a liquid jetting apparatus that jets or ejects some other liquid besides ink, and a liquid container for use in such a liquid jetting apparatus. Herein, the term liquid is used to include liquids in which particles of functional material have been dispersed in a medium; or fluids such as gels. Examples would be liquid jetting apparatus that jet fluids containing in dispersed or dissolved form materials such as electrode materials or coloring matter used in the manufacture of liquid crystal displays, EL (electroluminescence) displays, surface emitting displays, or color filters; liquid jetting apparatus used for jetting liquids containing bioorganic substances used in biochip manufacture; or specimen jetting devices used as precision pipettes. Further examples are liquid jetting apparatus used for pinpoint application of lubricants in precision instruments such as clocks or cameras; liquid jetting apparatus for jetting ultraviolet curing resins or other transparent resin solutions onto a substrate for the purpose of forming a micro semi-spherical lens (optical lens) for use in optical communication elements etc.; or liquid jetting apparatus for jetting acid or alkali etchant solution for etching circuit boards etc. The present invention is applicable to any of the above types of liquid jetting apparatus and to liquid containers for these liquid jetting apparatus.

(5) In the preceding embodiments, a piezoelectric device was employed as the sensor, but other types of sensor could also be used. For example, a type of sensor that measures the resistance of ink when an electrical current is passed through the ink would be acceptable. Nor is the sensor limited to one that detects remaining ink level; sensors that electrically detect ink viscosity, type, density etc. could be used as well. Generally speaking, any sensor for the purpose of electrically detecting the condition of a liquid such as ink is acceptable.

(6) In first embodiment and its variations, the metal plate 206, the valve member 41, and the nozzle plate 61b are disposed in contact with the ink; and the metal plate 206, the valve member 41, and the nozzle plate 61b are connected to a stable potential. However, this arrangement is not limiting, and any kind of conductor could be connected to the ink at any location in the ink reservoir section, with the conductor being electrically connected to a stable potential. For example, in FIG. 5, the film 80 that is used to form the chamber housing the ink inside the ink cartridge 1 could be a conductive film, and the conductive film electrically connected to the frame ground VSS. By so doing, the conductive film will substantially cover a parallel projection plane of ink inside the ink cartridge 1 viewed from the Y axis direction (FIG. 5), so interference by extraneous noise with the ink can be effectively limited.

(7) In the variation of second embodiment, the cartridge body is covered by a laminate composed of an insulating film 81 and a conducting film 82 in order to form electrostatic capacitance for the purpose of eliminating noise, but no particular limitation is imposed thereby. For example, of the cartridge body, the portion that forms the chamber housing the ink could be a thin section, and a conductor could be disposed to the outside of the thin section, with the conductor connected to the frame ground VSS. Generally speaking, in the ink reservoir section, the inside face that contacts the ink may be formed at least in part by an insulator, and a conductor may be disposed to the opposite side of the insulator from the inside face thereof that contacts the ink, with the conductor being connected to a stable potential.

(8) In the above embodiments and variations, the ink or electrostatic capacitance for the purpose of eliminating noise is connected to the frame ground VSS, but no particular limitation is imposed thereby, and connection to any fixed or stable potential would be acceptable. Specifically, connection to signal ground or earth potential would be acceptable.

(9) In the above embodiments, the shape of the ink cartridge, including the first and second ink reservoir chambers and the buffer chamber, are identified specifically; however, these are merely exemplary, and modifications and improvements thereto will be apparent to the skilled practitioner.

While the print control technology pertaining to the invention have been shown and described on the basis of the embodiments and variations, the embodiments of the invention described herein are merely intended to facilitate understanding of the invention, and implies no limitation thereof Various modifications and improvements of the invention are possible without departing from the spirit and scope thereof as recited in the appended claims, and these will naturally be included as equivalents in the invention.

What is claimed is:

1. A liquid container for supplying a liquid to a liquid jetting apparatus, the liquid container comprising:
a liquid reservoir section that stores electrically conductive liquid; and
a sensor disposed at a location in the liquid reservoir section, for electrically detecting a condition of the conductive liquid at the location,
wherein a fixed potential is applied to the conductive liquid.

2. A liquid container in accordance with claim 1 further comprising
a conducting portion that forms at least part of an inside face of the liquid reservoir section, the inside face contacting the conductive liquid, the conducting portion being electrically connected to a power supply that supplies the fixed potential.

3. A liquid container in accordance with claim 1, wherein
when the liquid container is installed in the liquid jetting apparatus, the conductive liquid contacts a conducting portion of the liquid jetting apparatus that is electrically connected to the fixed potential.

4. A liquid container in accordance with claim 1, wherein
the conductive liquid flows through an interior of the liquid reservoir section when being consumed by the liquid jetting apparatus, and
the conductive liquid is electrically connected to the fixed potential at an upstream side and a downstream side of the sensor.

5. A liquid container in accordance with claim 4, wherein
the liquid reservoir section includes a U-shaped channel that includes a first channel, a second channel at an upstream side of the first channel, and a third channel at an downstream side of the first channel
the sensor is situated along the first channel,
the liquid container further comprises:
a first conducting portion that defines at least part of an inside face of the second channel, the inside face of the second channel contacting the conductive liquid, the first conducting portion being electrically connected to the fixed potential; and
a second conducting portion that defines at least part of an inside face of the third channel, the inside face of the third channel contacting the conductive liquid, the second conducting portion being electrically connected to the fixed potential.

6. A liquid container in accordance with claim 5 further comprising:
a conducting member that includes the first conducting portion and the second conducting portion; and
a sensor module that includes the sensor and the first channel;
wherein the conducting member is a seating where the sensor module is situated.

7. A liquid container in accordance with claim 1, wherein
the liquid reservoir section includes a differential pressure regulating valve inside a channel that supplies the conductive liquid to the liquid jetting apparatus, the differential pressure regulating valve including a conductive member contacting the conductive liquid, and
the conductive member is connected to the fixed potential.

8. A liquid container in accordance with claim 7, wherein
the conductive member is electrically connected to the conductive liquid on an upstream side and the conductive liquid on a downstream side, and
when the liquid container is installed in the liquid jetting apparatus, the conductive liquid on the downstream side contacts a conducting portion of the liquid jetting apparatus that is electrically connected to the fixed potential.

9. A liquid container in accordance with claim 2, wherein
the first conducting portion substantially covers a projected area of the conductive liquid inside the liquid reservoir section viewed from a prescribed direction.

10. A liquid container in accordance with claim 3, wherein
the conducting portion is a nozzle member of the liquid jetting apparatus that has nozzles for jetting the conductive liquid.

11. A liquid container in accordance with claim 1, wherein
when the liquid container is installed in the liquid jetting apparatus, the conductive liquid is electrically connected to the frame ground of the liquid jetting apparatus having the fixed potential.
